(19) United States
(12) Patent Application Publication
(10) Pub. No.: US 2024/0281709 A1
(43) Pub. Date: Aug. 22, 2024

(54) TEXT ERROR CORRECTION METHOD AND SYSTEM, ELECTRONIC DEVICE, AND MEDIUM

(71) Applicant: Beijing Youzhuju Network Technology Co., Ltd., Beijing (CN)

(72) Inventors: Shaohua Zhang, Beijing (CN); Hongqiu Wu, Beijing (CN); Yuchen Zhang, Beijing (CN)

(21) Appl. No.: 18/441,328

(22) Filed: Feb. 14, 2024

(30) Foreign Application Priority Data
Feb. 16, 2023 (CN) 202310149733.0

(51) Int. Cl. G06N 20/00

(52) U.S. Cl. CPC G06N 20/00

(57) ABSTRACT

Embodiments of the disclosure relate to a text error correction method and system, an electronic device, and a medium. The method includes: obtaining a sample label including a source and a target, and randomly adding a mask to the source in the sample label to obtain the source with the mask; inputting the source with the mask into a training model to obtain a prediction result; calculating a precision and a recall according to the source, the target, and the prediction result of the sample label; calculating an average precision and an average recall for the precisions and the recalls of a plurality of sample labels, and calculating a harmonic mean F1 of the precisions and the recalls according to the average precision and the average recall; and adjusting the training model according to the harmonic mean F1, and taking the adjusted training model as a text error correction model.

### CROSS-REFERENCE TO RELATED APPLICATIONS

The present application is based on and claims priority of CN Application No. 202310149733.0, filed on Feb. 16, 2023, the disclosure of which is incorporated by reference herein in its entirety.

### TECHNICAL FIELD

The present disclosure relates to the field of machine learning and artificial intelligence, and specifically, to a text error correction method and system, an electronic device, and a medium.

### BACKGROUND

Text error correction aims to objectively correct user's text input, such as wrong characters and non-standard expressions.

### SUMMARY

The “SUMMARY” is provided to introduce concepts in a simplified form, which will be described in detail below in the following “DETAILED DESCRIPTION OF THE DRAWINGS”. The “SUMMARY” is not intended to identify key features or essential features of the claimed technical solutions, nor is it intended to limit the scope of the claimed technical solutions.

According to some embodiments of the present disclosure, there is provided a text error correction method, comprising: obtaining a sample label comprising a source and a target, and randomly adding a mask to the source in the sample label to obtain the source with the mask; inputting the source with the mask into a training model to obtain a prediction result; calculating a precision and a recall according to the source, the target, and the prediction result of the sample label; calculating an average precision and an average recall for the precisions and the recalls of a plurality of sample labels, and calculating a harmonic mean F1 of the precisions and the recalls according to the average precision and the average recall; and adjusting the training model according to the harmonic mean F1, and taking the adjusted training model as a text error correction model.

According to some embodiments of the present disclosure, there is provided a text error correction system, comprising: a mask addition unit configured to obtain a sample label comprising a source and a target, and randomly add a mask to the source in the sample label to obtain the source with the mask; a prediction unit configured to input the source with the mask into a training model to obtain a prediction result; a calculation unit configured to calculate a precision and a recall according to the source, the target, and the prediction result of the sample label, calculate an average precision and an average recall for the precisions and the recalls of a plurality of sample labels, and calculate a harmonic mean F1 of the precisions and the recalls according to the average precision and the average recall; and an adjustment unit configured to adjust the training model according to the harmonic mean F1, and take the adjusted training model as a text error correction model.

According to some embodiments of the present disclosure, there is provided an electronic device, comprising: a memory; and a processor coupled to the memory, the processor being configured to perform, based on instructions stored in the memory, the method according to any of the embodiments in the present disclosure.

According to some embodiments of the present disclosure, there is provided a computer-readable storage medium having thereon stored a computer program which, when executed by a processor, performs the method according to any of the embodiments in the present disclosure.

According to some embodiments of the present disclosure, there is provided a computer program product, comprising a computer program which, when executed by a processor, performs the method according to any of the embodiments in the present disclosure.

Other features and aspects of the present disclosure and advantages thereof will become apparent from the following detailed description of exemplary embodiments thereof, which proceeds with reference to the accompanying drawings.

### BRIEF DESCRIPTION OF THE DRAWINGS

Preferred embodiments of the present disclosure are described below with reference to the accompanying drawings. The accompanying drawings described here are used for providing a further understanding of the present disclosure, and the drawings together with the following specific description, are incorporated in and form a part of this specification, to explain the present disclosure. It should be understood that the drawings in the following description only relate to some embodiments of the present disclosure, rather than constituting a limitation on the present disclosure. In the drawings:

FIG. 1 shows a schematic diagram of a comparison between an accuracy of an error correction model in the related art on EXC and an accuracy thereof on INC.

FIG. 2 shows a schematic diagram of a distribution difference generated on a raw data distribution by a method using a confusion set that is represented by KL divergence.

FIG. 3 shows a schematic diagram of results of parameters obtained when different values of a mask addition ratio are attempted according to an exemplary embodiment of the present disclosure.

FIG. 4 shows a schematic diagram of a comparison between a distribution difference generated on a raw data distribution by a method using a confusion set that is represented by KL divergence and a distribution difference generated on a raw data distribution by using MFT of the present disclosure.

FIG. 5 shows a schematic flowchart of a training method of a text error correction system according to an exemplary embodiment of the present disclosure.

FIG. 6 shows a schematic diagram of a comparison between recalls of an MFT model and a finetune model.

FIG. 7 shows a schematic block diagram of a text error correction system according to an exemplary embodiment of the present disclosure.

FIG. 8 shows a schematic block diagram of an electronic device according to an exemplary embodiment of the present disclosure.

FIG. 9 shows a block diagram of an exemplary structure of a computer system that may be employed in an exemplary embodiment according to the present disclosure.

It should be understood that dimensions of various parts shown in the drawings are not necessarily drawn to actual scale for ease of description. Same or similar reference numbers are used throughout the drawings to represent same or similar components. Thus, once a certain item is defined in one drawing, it might not be further discussed in subsequent drawings.

### DETAILED DESCRIPTION

The technical solutions in the embodiments of the present disclosure will be described clearly and completely in conjunction with the drawings in the embodiments of the present disclosure, but it is obvious that the described embodiments are only some of the embodiments of the present disclosure, rather than all of the embodiments. The following description of the embodiments is merely illustrative in nature and is in no way used as any limitation on this disclosure and its application or uses. It should be understood that the present disclosure may be implemented in various forms and should not be construed as limited to the embodiments set forth herein.

It should be understood that various steps recited in method embodiments of the present disclosure may be performed in a different order, and/or performed in parallel. Moreover, the method embodiments may include additional steps and/or omit performing the illustrated steps. The scope of the present disclosure is not limited in this respect. Unless specifically stated otherwise, relative arrangements, numerical expressions, and numerical values of components and steps set forth in these embodiments should be construed as merely illustrative, and not limiting the scope of the present disclosure.

The term “comprise” and variations thereof used in this disclosure mean an open-minded term that comprises at least the following elements/features, but does not exclude other elements/features, i.e., “comprising but not limited to”. Furthermore, the term “include” and variations thereof used in this disclosure mean an open-minded term that includes at least the following elements/features, but does not exclude other elements/features, i.e., “including but not limited to”. Thus, “comprise” is synonymous with “include”. The term “based on” means “at least partially based on”.

“One embodiment”, “some embodiments”, or “an embodiment” termed throughout this specification means that a specific feature, structure, or characteristic described in conjunction with the embodiment is included in at least one embodiment of the present disclosure. For example, the term “one embodiment” means “at least one embodiment”; the term “another embodiment” means “at least one other embodiment”; the term “some embodiments” means “at least some embodiments”. Moreover, the appearances of the phrases “in one embodiment”, “in some embodiments”, or “in an embodiment” in various places throughout this specification do not necessarily all refer to the same one embodiment, but may also refer to the same one embodiment.

It should be noted that “first”, “second”, and other terms mentioned in the present disclosure are only used for distinguishing different devices, modules or units, and are not used for limiting the order or interdependence of functions performed by these devices, modules or units. Unless otherwise specified, the “first”, “second”, and other terms are not intended to imply that objects so described must be in a given order in time, space, or ranking, or otherwise.

It should be noted that modifications of “a” or “a plurality” mentioned in this disclosure are intended to be illustrative rather than limiting, and that those skilled in the art should appreciate that they should be understood as “one or more” unless otherwise explicitly stated in the context.

Names of messages or information exchanged between a plurality of devices in the embodiments of the present disclosure are for illustrative purposes only, and are not intended to limit the scope of the messages or information.

The embodiments of the present disclosure will be described in detail below in conjunction with the accompanying drawings, but the present disclosure is not limited to these specific embodiments. These specific embodiments may be combined below with each other, and same or similar concepts or processes might not be repeated in certain embodiments. Furthermore, in one or more embodiments, specific features, structures, or characteristics may be combined in any suitable manner that would be understood by one of ordinary skill in the art from this disclosure.

Through learning of big data, a previous error correction model can effectively correct a common error, but it has difficulty in learning an error pattern that has not yet been seen. However, for a generic error correction system that needs to serve in a plurality of different fields, it is difficult for the model to see all types of errors in training due to differences in related expressions and knowledge between the fields.

The problem of poor universality of the error correction model in the related art in scenarios of a plurality of fields can come down to the fact that, the previous error correction model can effectively correct a common error, but has difficulty in learning an error pattern that has not yet been seen. For example, in a test set of SIGHAN, for errors in 67% of samples, identical errors have occurred in a training set (this part of errors are denoted as INC (inclusive)), while the remaining 33% of samples have not occurred (this part of errors are denoted as EXC (exclusive)).

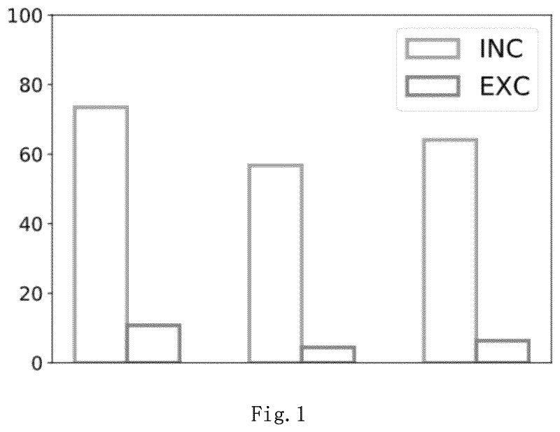

The previous error correction model fits well for those edit points that have occurred in the training set, however, its accuracy on EXC is very low, as shown in FIG. 1. In FIG. 1, from left to right are a precision, a recall, and F1, respectively, which all have a sudden drop on EXC. The precision is a proportion of correct predictions being positive to all predictions being positive, the recall is a proportion of correct predictions being positive to all actualities being positive, and F1 is a harmonic mean of the precision and the recall. According to a preferred embodiment of the present disclosure, F1 may be calculated by an equation:

$$F 1 = \frac{2 * precision * recall}{( precision + recall )} .$$

F1 considers both the precision and the recall, making both maximized at the same time so that a balance is achieved.

The above problem is called a generalization ability, which refers to a performance of a model on data that has not yet been seen.

A method using a confusion set to generate more extensive types of errors to augment original error correction training data can simply and effectively generate common error patterns, enabling the model to have a better performance. Taking a simple example, a target is: [symbol] . According to the confusion set, there is a certain probability that “ [symbol] ” will be written as “ [symbol] ”, so that replacement is made to obtain a source: [symbol] .

Data augmentation is a method for improving learning efficiency of the error correction model, wherein for error correction data, an error content in one sentence is very low (usually 0 to 1 error), so the model has low learning efficiency. One conventional way to augment the error correction data is to replace a character in a sentence using a confusion set, to increase the error content, such as “ [symbol] ”→“ [symbol] ”.

However, the confusion set can seriously change a raw distribution of the data, resulting in an uncontrollable training performance in a plurality of fields, and thereby bringing a negative effect.

A difference between distributions of the training set and the test set before and after data augmentation is measured using KL (Kullback-Leibler) divergence. The KL divergence is a statistic that measures the difference between two distributions, its greater value indicating a greater difference.

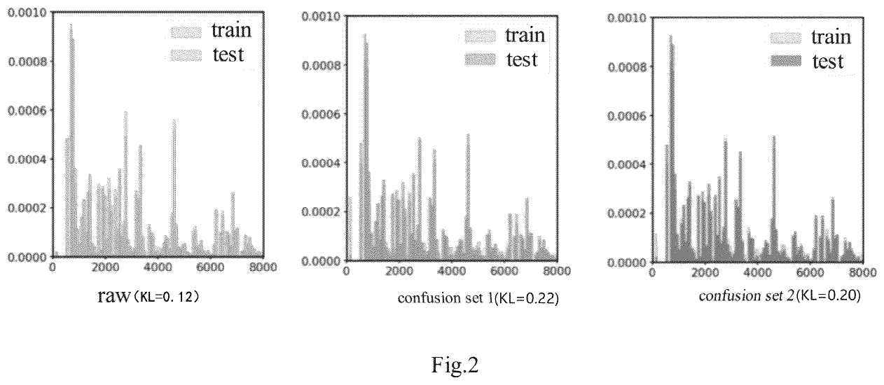

Referring to FIG. 2, where KL refers to the KL divergence, it can be seen that the method using the confusion set can generate a greater distribution difference for the raw data distribution.

Based on this, the present disclosure provides a masked fine tuning (MFT) error correction system, which can solve the problem of poor generalization ability of the error correction model, without affecting the raw data distribution. MFT is a goal for training, i.e., an optimization goal when the model is trained.

An input, i.e. a source, to a training goal for conventional error correction is a sentence that originally needs error correction. The error correction model needs to detect and correct an error in the source and output a result, i.e., a target. For example, for “ [symbol] ”→“ [symbol] ”, the former is a source, and the latter is a target.

According to an embodiment of the present disclosure, MFT randomly adds a mask (e.g., [MASK]) in a source, i.e., randomly mask a character in the source. Replacing a character in the source with a mask can also be considered a type of data augmentation. The error correction model not only needs to correct a wrong character, but also needs to restore characters existing originally at these masked positions according to the context.

According to an embodiment of the present disclosure, there are generally two cases of MFT randomly masking a character in the source. A first case is that a correct character is masked, such as “ [symbol] [MASK] [symbol] ”→“ [symbol] ”, so that in this case, MFT needs to deduce by the context that a position of [MASK] is “ [symbol] ”. A second case is that a wrong character is masked, such as “ [symbol] [MASK]∘”→“ [symbol] ”, so that in this case, MFT does not know whether there is a wrong character in the source, and needs to deduce by the context that a position of the [MASK] is “ [symbol] ”.

That is, MFT not only needs to learn correcting the wrong character, but also needs to learn the context in the sentence to restore the randomly masked character. According to an embodiment of the present disclosure, MFT prefers making the model performing error correction by the context to by learning the wrong character. Like “ [symbol] ”->“ [symbol] ” in the above example, if the model excessively memorizes the mapping of such a wrong character, final universality will be damaged, as there are various cases in reality, and the “ [symbol] ” does not need to be corrected in some contexts, so that what the model really needs to learn is to perform reasonable error correction through the context. This enhances the generalization ability of the error correction model, thereby making it have more universality.

According to an embodiment of the present disclosure, MFT is mainly applied to a fine tuning stage of pre-training a language model.

In the mask addition, those special symbols and English letters should be excluded, only masking plain text, but determining whether a character at one position is plain text or not will reduce operating efficiency, and it has been found through experiments that the benefit brought by only masking plain text is very limited. Therefore, an embodiment of the present disclosure preferably adopts a simplest and fastest implementation of uniformly selecting a certain ratio of characters in an input sentence for masking, i.e., replacing them with [MASK].

In the field of language error correction, a performance of an error correction model is usually measured by using a harmonic mean F1 of the precisions and the recalls. On this basis, an inclusive F1 and an exclusive F1, which can be respectively abbreviated as I-F1 and E-F1, are provided herein. I-F1 refers to F1 of the model on those errors having been seen in training, so that the key is “the model has seen the errors”. E-F1 refers to F1 of the model on those errors having not been seen in training, so that the key is “the model has not seen the errors”. By characterization with I-F1 and E-F1, the generalization ability of the error correction model can be better measured.

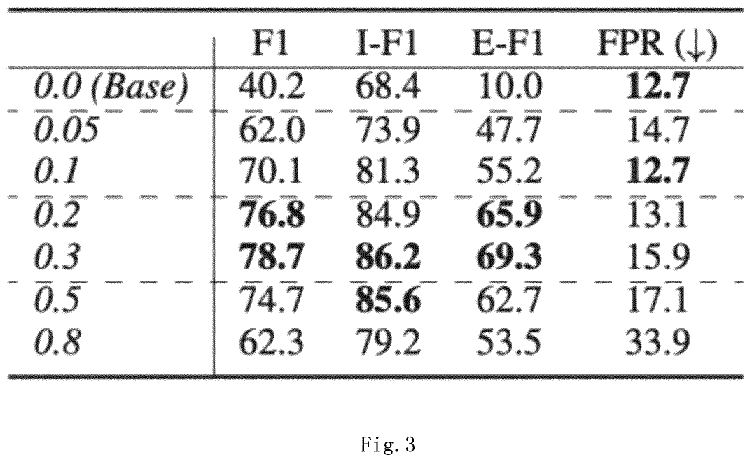

With respect to the ratio of the mask addition, the present disclosure attempts different values (0.1, 0.2, 0.3, 0.4, 0.5). As shown in FIG. 3, when the addition ratio of the mask is 0.3, F1, I-F1, and E-F1 are all the highest. When the ratio is too high, such as when the ratio is 0.4 or 0.5, there is a clear decrease in the performance because too much masks will destroy the context, making the model unable to predict correctly.

However, as shown in FIG. 3, after the ratio exceeds 0.2, a false positive rate (FPR) increases significantly. The false positive rate is a rate at which the model considers a character that is originally correct as a wrong one. In practical application, a low false positive rate is needed.

Therefore, on balance, when the addition ratio of the mask is 0.2, comprehensive performances of F1 and FPR are optimal.

Although not shown in FIG. 3, in the present disclosure, experiments are also made on parameters when the addition ratio of the mask is 0.15, obtaining F1=75.6, I-F1=83.1, E-F1=64.8, and FPR=13.5 when the mask is 0.15; it can be seen that the values of F1, I-F1, and E-F1 are all lower than those when the mask is 0.2, while FPR is higher than that when the mask is 0.2, and thus each parameter performs not as good as that when the mask is 0.2.

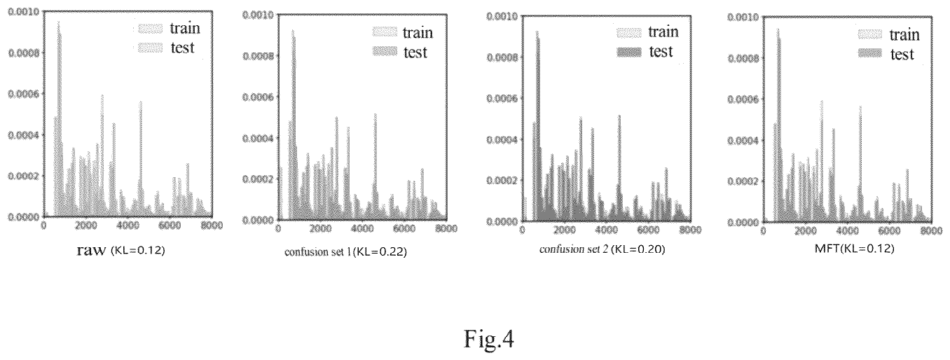

FIG. 4 shows a comparison after adding MFT provided by the present disclosure on the basis of FIG. 2. Referring to FIG. 4, it can be seen that the method of using a confusion set will generate a large distribution difference on the raw data distribution, while MFT of the present disclosure will not have any influence on the raw data distribution.

The present disclosure theoretically proves that the error correction language model is a replacement method under the raw language model distribution, which is a generic form of the confusion set-based method. In other words, the confusion set is an approximation of MFT. In the confusion set method, the default is generally that weights are uniform,

$$i . e . , \frac{1}{\vert Vt \vert} ,$$

where Vt is a confusion set. But from the perspective of an entire corpus, the weights are not

$$\frac{1}{\vert Vt \vert} ,$$

so that this is an approximation. Second, Vt is not equal to V, but is much smaller than V (where V is a complete corpus, so that this is also an approximation).

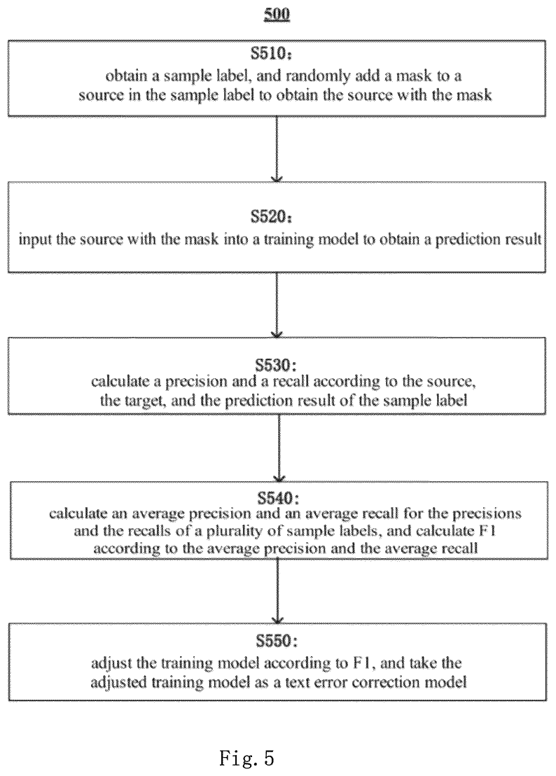

FIG. 5 shows a schematic flowchart 500 of a training method of a text error correction system according to an embodiment of the present disclosure.

As shown in FIG. 5, at step S510, a sample label is obtained, and a mask is randomly added to a source in the sample label, to obtain the source with the mask. Here, the sample label comprises the source and a target.

According to an exemplary embodiment of the present disclosure, a source is “ [symbol] ”, and a target is “ [symbol] [symbol] ”. As described above, a ratio of randomly adding a mask is preferably 0.2. In “ [symbol] ” are 6 characters in all, then one mask may be added. For example, a source with a mask that is obtained by randomly adding a mask is “ [symbol] [MASK] [symbol] ”.

At step S520, the source with the mask is input into a training model to obtain a prediction result. The training model herein may be a common training model in the art.

Still taking the above example for description, a prediction result “ [symbol] ” is obtained.

At step S530, a precision and a recall are calculated according to the source, the target, and the prediction result of the sample label.

In the above example, the prediction result “ [symbol] ” is consistent with the target “ [symbol] ”, so that a precision P and a recall R of the MFT correction system are both 100%.

In another example, a source of a sample label is “ [symbol] [symbol] ”, a target is “ [symbol] ”, and on the basis of randomly adding a mask, a prediction result is “ [symbol] ”, then a precision P and a recall R of the MFT correction system are both 0.

In yet another example, a source of a sample label is “ [symbol] [symbol] ”, the target is “ [symbol] ”, and on the basis of randomly adding a mask, a prediction result is “ [symbol] ”, then a precision P and a recall R of the MFT correction system are 0 and 100%, respectively.

At step S540, an average precision and an average recall are calculated for the precisions and the recalls of a plurality of sample labels, and F1 is calculated according to the average precision and the average recall.

According to an embodiment of the present disclosure, F1 is calculated according to a formula

$$F 1 = \frac{2 * precision * recall}{( precision + recall )} .$$

At step S550, the training model is adjusted according to F1, and the adjusted training model is taken as a text error correction model. According to the embodiment of the present disclosure, only when F1 is above a certain threshold, the training model can be taken as the text error correction model. For example, the threshold may be different when applied to different correction benchmarks, or when used in different fields (e.g., law, healthcare, document writing, etc.). According to the applied error correction benchmark and/or the applied field, a user may set the threshold according to actual needs.

According to an embodiment of the present disclosure, after a text error correction model with F1 above a certain threshold is obtained, a source to be corrected may be input into the text error correction model, to obtain a corrected sentence.

According to a preferred embodiment of the present disclosure, the sample labels can be classified into two parts, one part being sample labels where errors therein have been seen by the training model, and the other part being sample labels where errors therein have not been seen by the training model. That is, according to whether an error in the source occurs for the first time for the training model, the plurality of sample labels are classified into two classes, a first class being sample labels where the error in the source occurs for the first time for the training model, and a second class being sample labels where the error in the source does not occur for the first time for the training model. Precisions and recalls of the sample labels in the two classes are respectively averaged to obtain an average precision and an average recall of the first-class sample labels and an average precision and an average recall of the second-class sample labels. Then, E-F1 is calculated according to the average precision and the average recall of the first-class sample labels, and I-F1 is calculated according to the average precision and the average recall of the second-class sample labels, where E-F1 is F1 of the training model on those errors having not been seen in training, and I-F1 is F1 of the training model on those errors having been seen in training.

The learning method of masked fine tuning error correction training that is provided in the present disclosure can greatly improve the learning efficiency of the model, thereby having more universality. The masked fine tuning error correction learning method in the present disclosure can be applied to an error correction model for any language.

The MFT error correction training method in the present disclosure is applied to a common Chinese error correction benchmark: Special Interest Group for Chinese Language Processing of the Association for Computational Linguistics (SIGHAN) and another Chinese error correction benchmark: Error Consistent Spelling (ECSpell), both being able to achieve a highest-level performance. The MFT error correction training method in the present disclosure is applied to few-sample (even zero-sample) learning, achieving a performance far beyond a baseline model (BERT).

According to an exemplary embodiment of the present disclosure, a comparison is made between the MFT model of the present disclosure and a finetune model.

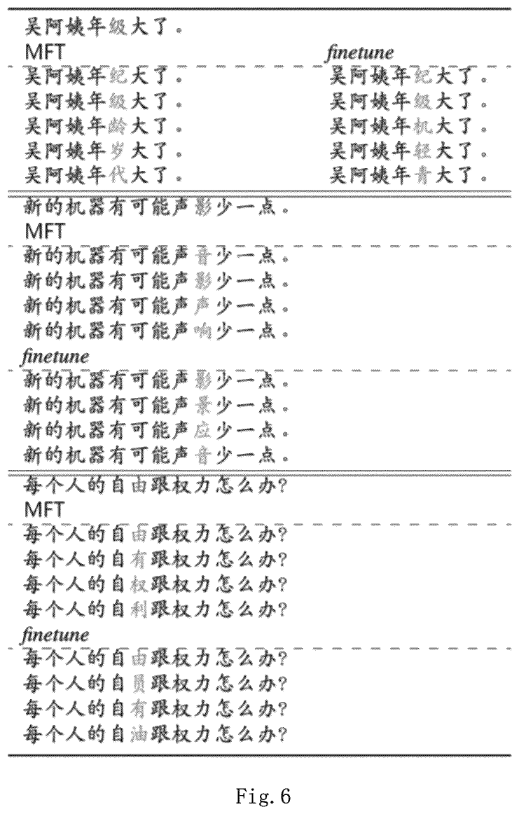

As shown in FIG. 6, for same sources “ [symbol] ”, “ [symbol] [symbol] ”, and “ [symbol] ” candidate characters recalled by the MFT model of the present disclosure and different from those recalled by the finetune model.

The MFT model can recall a plurality of candidates that fit the current context, such as “ [symbol] ”, “ [symbol] ”, while the finetune model prefers recalling wrong characters, such as “ [symbol] ” (which is homophonic), “ [symbol] ” (which is isomorphic).

As shown in Tables 1 to 4 below, by comparing with various different models when applied to different error correction benchmarks, it can be seen that the application of MFT of the present disclosure causes various performances to be significantly improved not only on E-F1, but also on I-F1, which shows that the training method provided in the present disclosure indeed improves the generalization ability of the model. The parameters in Tables 1 to 4 are all obtained on the basis of the mask addition ratio of 0.2.

TABLE 1
comparisons between precision, recall and F1 parameters

| SIGHAN | Precision | Recall | F1 |
|---|---|---|---|
| BERT-finetune | 73.0 | 72.6 | 72.8 |
| MFT | 76.7 | 79.1 | 77.9 |
| BERT-SoftMasked | 67.6 | 72.8 | 70.1 |
| MFT | 76.3 | 81.5 | 78.9 |
| SpellGCN | 72.1 | 77.7 | 74.8 |
| DCN | 74.2 | 77.3 | 75.7 |
| REALISE | 75.9 | 79.9 | 77.8 |
| ECSpell | 74.4 | 77.9 | 76.1 |

TABLE 2
F1 comparisons in fields of law, healthcare, and document writing

| ECSpell | Law | Healthcare | Document Writing |
|---|---|---|---|
| BERT-finetune | 40.2 | 26.9 | 26.7 |
| MFT | 76.8 | 63.8 | 62.9 |

TABLE 3
F1 comparisons in fields of law, healthcare and document writing

| Zero-sample | Law | Healthcare | Document Writing |
|---|---|---|---|
| BERT-finetune | 53.0 | 53.5 | 54.8 |
| MFT | 57.5 | 56.9 | 64.5 |

TABLE 4
I-F1 and E-F1 comparisons in fields of
law, health care and document writing

| | Law | | Healthcare | | Document Writing | |
|---|---|---|---|---|---|---|
| | I-F1 | E-F1 | I-F1 | E-F1 | I-F1 | E-F1 |
| BERT-finetune | 68.4 | 10.0 | 35.6 | 5.7 | 54.4 | 7.4 |
| MFT | 84.9 | 65.9 | 46.7 | 43.2 | 71.3 | 42.4 |

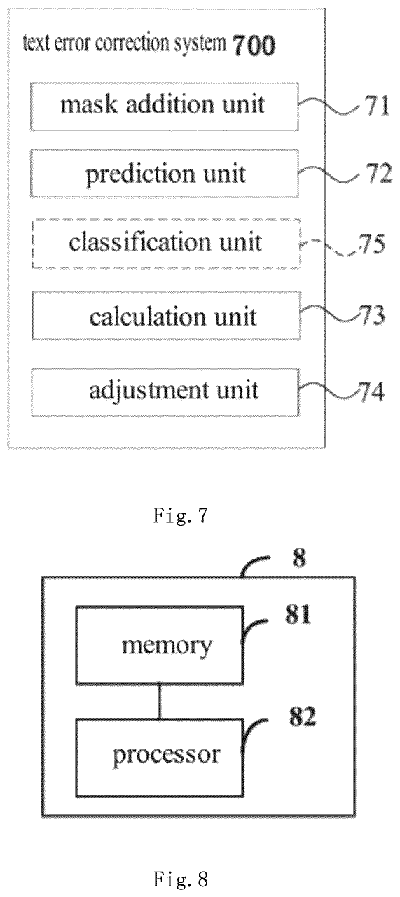

FIG. 7 shows a block diagram of a text error correction system 700 according to an exemplary embodiment of the present disclosure.

As shown in FIG. 7, the text error correction system 700 comprises a mask addition unit 71 configured to obtain a sample label, and randomly add a mask to a source in the sample label to obtain the source with the mask. Here, the sample label comprises the source and a target. As described previously, a ratio of randomly adding the mask is preferably 0.2.

As shown in FIG. 7, the text error correction system 700 further comprises a prediction unit 72 configured to input the source with the mask into a training model to obtain a prediction result.

As shown in FIG. 7, the text error correction system 700 further comprises a calculation unit 73 configured to calculate a precision and a recall according to the source, the target, and the prediction result of the sample label, calculate an average precision and an average recall for the precisions and the recalls of a plurality of sample labels, and calculate F1 according to the average precision and the average recall.

As shown in FIG. 7, the text error correction system 700 further comprises an adjustment unit 74 configured to adjust the training model according to F1, and take the adjusted training model as a text error correction model.

According to an embodiment of the present disclosure, the adjustment unit 74 compares F1 with a certain threshold, and takes the training model as the text error correction model only when F1 is above the threshold. For example, the threshold may be different when applied to different error correction benchmarks, or when used in different fields (e.g., law, healthcare, document writing, etc.). According to the applied error correction benchmark and/or the applied field, a user may set the threshold according to actual needs.

According to an embodiment of the present disclosure, after the text error correction model with F1 above the certain threshold is obtained, the prediction unit 72 may be further configured to input a source to be corrected into the text error correction model, to obtain a corrected sentence.

As shown in FIG. 7, the text error correction system 700 may further comprise a classification unit 75 configured to, according to whether an error in the source occurs for the first time for the training model, classify the plurality of sample labels into two classes, a first class being sample labels where the error in the source occurs for the first time for the training model, and the second class being sample labels where the error in the source does not occur for the first time for the training model.

Furthermore, according to an embodiment of the present disclosure, the calculation unit 73 may be further configured to average precisions and recalls of the plurality of sample labels in the first class and the second class, respectively, to obtain an average precision and an average recall of the first-class sample labels and an average precision and an average recall of the second-class sample labels, and calculate E-F1 according to the average precision and the average recall of the first-class sample labels, and calculate I-F1 according to the average precision and the average recall of the second-class sample labels. E-F1 is F1 of the training model on those errors having not been seen in training, and I-F1 is F1 of the training model on those errors having been seen in training.

The text error correction system provided by the embodiment of the present disclosure can implement the learning method of the masked fine tuning error correction training provided by the above embodiment, and have the similar implementation principle and technical effect, so that they are not repeated herein.

The masked fine tuning Chinese error correction system disclosed by this application can serve in various scenarios, such as chatting, news, game conversations, and forums, to improve quality of content.

Some embodiments of the present disclosure also provide an electronic device. FIG. 8 shows a block diagram of an electronic device 8 according to some embodiments of the present disclosure. The electronic device may be used for implementing the method according to any embodiment of the present disclosure.

For example, in some embodiments, the electronic device 8 may be various types of devices, which may include, for example, but are not limited to, mobile terminals such as a mobile phone, a notebook computer, a digital broadcast receiver, a PDA (personal digital assistant), a PAD (tablet computer), a PMP (portable multimedia player), and a vehicle-mounted terminal (e.g., a vehicle-mounted navigation terminal), and fixed terminals such as a digital TV and a desktop computer. For example, the electronic device 8 may include a display panel for displaying data and/or execution results used in the solutions according to the present disclosure. For example, the display panel may be various shapes such as a rectangular panel, an oval panel, or a polygonal panel. In addition, the display panel can be a planar panel, a curved panel, or even a spherical panel.

As shown in FIG. 8, the electronic device 8 of this embodiment comprises: a memory 81 and a processor 82 coupled to the memory 81. It should be noted that the components of the electronic device 8 shown in FIG. 8 are only exemplary and not limiting, and the electronic device 8 may have other components according to actual application needs. The processor 82 may control the other components in the electronic device 8 to perform desired functions.

In some embodiments, the memory 81 is configured to store one or more computer-readable instructions. The processor 82 is configured to execute the computer-readable instructions, which when executed by the processor 82, implement the method according to any of the embodiments described above. For specific implementations of the steps of the method and related explanation thereof, reference may be made to the foregoing embodiments, so that the repetition is not elaborated herein.

For example, the processor 82 and the memory 81 may be in direct or indirect communication with each other. For example, the processor 82 and the memory 81 may communicate over a network. The network may include a wireless network, a wired network, and/or any combination of wireless and wired networks. The processor 82 and the memory 81 may also communicate with each other via a system bus, which is not limited in the present disclosure.

For example, the processor 82 may be embodied as various suitable processors, processing devices, and the like, such as a central processing unit (CPU), a graphics processing unit (GPU), and a network processor (NP); and may also be a digital signal processor (DSP), an application specific integrated circuit (ASIC), a field programmable gate array (FPGA) or other programmable logic devices, a discrete gate or transistor logic device, a discrete hardware component. The central processing unit (CPU) may be an X86 or ARM architecture, etc. For example, the memory 81 may include any combination of various forms of computer-readable storage media, such as a volatile memory and/or a non-volatile memory. The memory 81 may include, for example, a system memory, which has stored thereon, for example, an operating system, an application, a boot loader, a database, other programs, and the like. Various applications, various data, and the like, can also be stored in the storage medium.

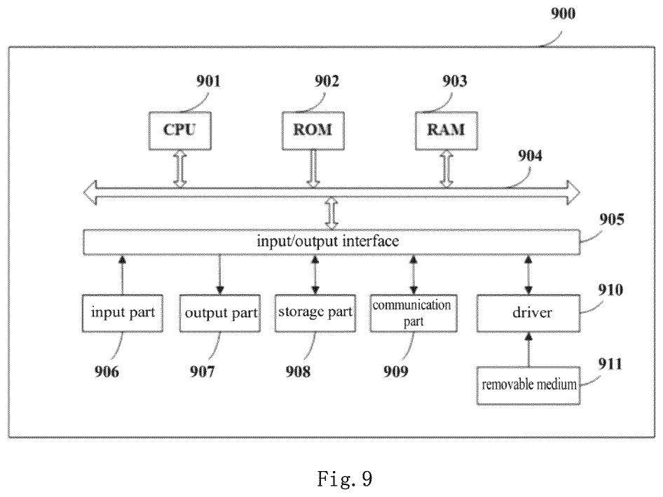

In addition, according to some embodiments of the present disclosure, in the case where various operations/processes according to the present disclosure are implemented by software and/or firmware, a program constituting the software may be installed from a storage medium or a network to a computer system having a dedicated hardware structure, for example, a computer system 900 shown in FIG. 9, wherein the computer system is capable of performing various functions including functions such as those described above when it has the various programs installed thereon. FIG. 9 shows a block diagram of an example structure of a computer system that may be employed according to an embodiment of the present disclosure.

In FIG. 9, a central processing unit (CPU) 901 performs various processes according to a program stored in a read-only memory (ROM) 902 or a program loaded from a storage part 908 to a random access memory (RAM) 903. In the RAM 903, data needed when the CPU 901 executes various processes and the like is also stored as needed. The central processing unit is merely exemplary, and it may be other types of processors, such as the various processors described above. The ROM 902, RAM 903, and storage part 908 may be various forms of computer-readable storage media, as described below. It should be noted that although the ROM 902, RAM 903, and storage part 908 are respectively shown in FIG. 9, one or more of them may be merged or located in same or different memories or storage modules.

The CPU 901, ROM 902, and RAM 903 are connected with each other via a bus 904. An input/output interface 905 is also connected to the bus 904.

The following components are connected to the input/output interface 905: an input part 906 such as a touch screen, a touch pad, a keyboard, a mouse, an image sensor, a microphone, an accelerometer, and a gyroscope; an output part 907, including a display such as a cathode ray tube (CRT), a liquid crystal display (LCD), a speaker, and a vibrator; the storage part 908, including a hard disk, a magnetic tape, and the like; and a communication part 909, including a network interface card such as a LAN card and a modem. The communication part 909 allows communication processes to be performed via a network such as the Internet. It will be readily appreciated that while the various devices or modules in the computer system 900 shown in FIG. 9 communicate via the bus 904, they may also communicate over a network or in another way, wherein the network may include a wireless network, a wired network, and/or any combination of wireless and wired networks.

A driver 910 is also connected to the input/output interface 905 as needed. A removable medium 911 such as a magnetic disk, an optical disk, a magneto-optical disk, and a semiconductor memory is mounted on the driver 910 as needed, so that a computer program read out therefrom is installed into the storage part 908 as needed.

In the case of implementing the above series of processes by software, a program constituting the software may be installed from a network such as the Internet or a storage medium such as the removable medium 911.

According to an embodiment of the present disclosure, the process described above with reference to the flowchart may be implemented as a computer software program. For example, an embodiment of the present disclosure includes a computer program product, which comprises a computer program carried on a computer-readable medium, the computer program including program code for performing the method illustrated by the flowchart. In such an embodiment, the computer program may be downloaded and installed from a network through the communication part 909, or installed from the storage part 908, or installed from the ROM 902. The computer program, when executed by the CPU 901, performs the above functions defined in the method of the embodiment of the present disclosure.

It should be noted that in the context of this disclosure, a computer-readable medium may be a tangible medium, which can contain, or store a program for use by or in conjunction with an instruction execution system, apparatus, or device. The computer-readable medium may be a computer-readable signal medium or a computer-readable storage medium or any combination of the two. The computer-readable storage medium may be, for example, but is not limited to: an electronic, magnetic, optical, electromagnetic, infrared, or semiconductor system, apparatus, or device, or any combination of the foregoing. More specific examples of the computer-readable storage medium may include, but are not limited to: an electrical connection having one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, the computer-readable storage medium may be any tangible medium containing or storing a program, wherein the program can be used by or in conjunction with an instruction execution system, apparatus, or device. However, in the present disclosure, the computer-readable signal medium may include a data signal propagated in baseband or as part of a carrier wave, in which computer-readable program code is carried. Such a propagated data signal may take a variety of forms, including, but not limited to, an electromagnetic signal, an optical signal, or any suitable combination of the forgoing. The computer-readable signal medium may also be any computer-readable medium other than the computer-readable storage medium, wherein the computer-readable signal medium can send, propagate, or transmit a program for use by or in conjunction with an instruction execution system, apparatus, or device. The program code contained on the computer-readable medium may be transmitted using any appropriate medium, including but not limited to: a wire, an optical cable, RF (Radio Frequency), etc., or any suitable combination of the foregoing.

The above computer-readable medium may be contained in the above electronic device; or may be exist separately without being assembled into the electronic device.

In some embodiments, there is also provided a computer program, comprising: instructions which, when executed by a processor, cause the processor to perform the method of any of the embodiments described above. For example, the instructions may be embodied as computer program code.

In an embodiment of the present disclosure, computer program code for performing the operations of the present disclosure may be written in one or more programming languages or a combination thereof, wherein the above programming language includes but is not limited to an object-oriented programming language such as Java, Smalltalk, and C++, and also includes a conventional procedural programming language, such as a “C” language or a similar programming language. The program code may be executed entirely on a user's computer, partly on the user's computer, as a stand-alone software package, partly on the user's computer and partly on a remote computer, or entirely on the remote computer or server. In a scenario where the remote computer is involved, the remote computer may be connected to the user's computer through any type of network (including a local area network (LAN) or a wide area network (WAN)), or may be connected to an external computer (for example, through the Internet using an Internet service provider).

The flowcharts and block diagrams in the drawings illustrate the possibly implemented architecture, functions, and operations of the system, method and computer program product according to various embodiments of the present disclosure. In this regard, each block in the flowcharts or block diagrams may represent a module, program segment, or part of code, which includes one or more executable instructions for implementing a specified logical function. It should also be noted that, in some alternative implementations, functions noted in blocks may occur in a different order from those noted in the drawings. For example, two blocks shown in succession may, in fact, be executed substantially concurrently, or they may sometimes be executed in a reverse order, which depends upon the functions involved. It will also be noted that each block in the block diagrams and/or flowcharts, and a combination of the blocks in the block diagrams and/or flowcharts, can be implemented by a special-purpose hardware-based system that performs specified functions or operations, or a combination of special-purpose hardware and computer instructions.

The involved module, component or unit described in the embodiments of the present disclosure may be implemented by software or hardware. The name of the module, component or unit does not, in some cases, constitute a limitation on the module, component or unit itself.

The functions described above herein may be executed, at least partially, by one or more hardware logic components. For example, without limitation, an exemplary hardware logic component that may be used includes: a field programmable gate array (FPGA), an application specific integrated circuit (ASIC), an application specific standard parts (ASSP), a system on chip (SOC), a complex programmable logic device (CPLD), and the like.

According to some embodiments of the present disclosure, there is provided a text error correction method, comprising: obtaining a sample label comprising a source and a target, and randomly adding a mask to the source in the sample label to obtain the source with the mask; inputting the source with the mask into a training model to obtain a prediction result; calculating a precision and a recall according to the source, the target, and the prediction result of the sample label; calculating an average precision and an average recall for the precisions and the recalls of a plurality of sample labels, and calculating a harmonic mean F1 of the precisions and the recalls according to the average precision and the average recall; and adjusting the training model according to the harmonic mean F1, and taking the adjusted training model as a text error correction model.

According to some embodiments of the present disclosure, the harmonic mean

$$F 1 = \frac{2 * precision * recall}{( precision + recall )} .$$

According to some embodiments of the present disclosure, the text error correction method further comprises: according to whether an error in the source occurs for the first time for the training model, classifying the plurality of sample labels into two classes, a first class being sample labels where the error in the source occurs for the first time for the training model, and a second class being sample labels where the error in the source does not occur for the first time for the training model.

According to some embodiments of the present disclosure, the text error correction method further comprises: averaging precisions and recalls of the plurality of sample labels in the first class and the second class, respectively, to obtain an average precision and an average recall of the first-class sample labels and an average precision and an average recall of the second-class sample labels; and calculating E-F1 according to the average precision and the average recall of the first-class sample labels, and calculating I-F1 according to the average precision and the average recall of the second-class sample labels, wherein E-F1 is a harmonic mean F1 of the precisions and the recalls of the training model on those errors having not been seen in training, and I-F1 is a harmonic mean F1 of the precisions and the recalls of the training model on those errors having been seen in training.

According to some embodiments of the present disclosure, a ratio of randomly adding the mask to the source is 0.1 to 0.3, preferably 0.2.

According to some embodiments of the present disclosure, the text error correction method further comprises: inputting a source to be corrected into the text error correction model to obtain a corrected target.

According to some embodiments of the present disclosure, there is provided a text error correction system, comprising: a mask addition unit configured to obtain a sample label comprising a source and a target, and randomly add a mask to the source in the sample label to obtain the source with the mask; a prediction unit configured to input the source with the mask into a training model to obtain a prediction result; a calculation unit configured to calculate a precision and a recall according to the source, the target, and the prediction result of the sample label, calculate an average precision and an average recall for the precisions and the recalls of a plurality of sample labels, and calculate a harmonic mean F1 of the precisions and the recalls according to the average precision and the average recall; and an adjustment unit configured to adjust the training model according to the harmonic mean F1, and take the adjusted training model as a text error correction model.

According to some embodiments of the present disclosure, the harmonic mean

$$F 1 = \frac{2 * precision * recall}{( precision + recall )} .$$

According to some embodiments of the present disclosure, the text error correction system further comprises: a classification unit configured to, according to whether an error in the source occurs for the first time for the training model, classify the plurality of sample labels into two classes, a first class being sample labels where the error in the source occurs for the first time for the training model, and a second class being sample labels where the error in the source does not occur for the first time for the training model.

According to some embodiments of the present disclosure, the calculation unit is further configured to: average precisions and recalls of the plurality of sample labels in the first class and the second class, respectively, to obtain an average precision and an average recall of the first-class sample labels and an average precision and an average recall of the second-class sample labels; and calculate E-F1 according to the average precision and the average recall of the first-class sample labels, and calculating I-F1 according to the average precision and the average recall of the second-class sample labels, wherein E-F1 is a harmonic mean F1 of the precisions and the recalls of the training model on those errors having not been seen in training, and I-F1 is a harmonic mean F1 of the precisions and the recalls of the training model on those errors having been seen in training.

According to some embodiments of the present disclosure, a ratio of randomly adding the mask to the source is 0.1 to 0.3, preferably 0.2.

According to some embodiments of the present disclosure, the prediction unit is further configured to: input a source to be corrected into the text error correction model to obtain a corrected target.

According to some embodiments of the present disclosure, there is provided an electronic device, comprising: a memory; and a processor coupled to the memory, the memory having therein stored instructions which, when executed by the processor, cause the electronic device to perform the method of any of the embodiments in the present disclosure.

According to some embodiments of the present disclosure, there is provided a computer-readable storage medium having thereon stored a computer program which, when executed by a processor, performs the method of any of the embodiments in the present disclosure.

According to some embodiments of the present disclosure, there is provided a computer program product, comprising a computer program which, when executed by a processor, performs the method of any of the embodiments in the present disclosure.

The foregoing description is only some embodiments of the present disclosure and an explanation of the technical principles employed. It should be appreciated by those skilled in the art that the disclosure scope involved in the present disclosure is not limited to the technical solutions formed by specific combinations of the technical features described above, but also encompasses other technical solutions formed by arbitrary combinations of the above technical features or equivalent features thereof without departing from the above disclosed concepts, for example, a technical solution formed by performing mutual replacement between the above features and technical features having similar functions to those disclosed (but not limited to) in the present disclosure.

In the description provided herein, numerous specific details are set forth. However, it is understood that the embodiments of the present disclosure may be implemented without these specific details. In other cases, well-known methods, structures and techniques have not been shown in detail in order not to obscure the understanding of the description.

Furthermore, while operations are depicted in a specific order, this should not be understood as requiring that these operations be performed in the specific order shown or in a sequential order. Under certain circumstances, multitasking and parallel processing might be advantageous. Similarly, while several specific implementation details are included in the above discussion, these should not be construed as limitations on the scope of the present disclosure. Certain features that are described in the context of separate embodiments may also be implemented in combination in a single embodiment. Conversely, various features that are described in the context of a single embodiment may also be implemented in multiple embodiments separately or in any suitable sub-combination.

Although some specific embodiments of the present disclosure have been described in detail by examples, it should be understood by those skilled in the art that the above examples are for illustration only and are not intended to limit the scope of the present disclosure. Those skilled in the art should appreciate that modifications may be made to the above embodiments without departing from the scope and spirit of the present disclosure. The scope of the present disclosure is defined by the attached claims.

What is claimed is:

1. A text error correction method, comprising:
obtaining a sample label comprising a source and a target, and randomly adding a mask to the source in the sample label to obtain the source with the mask;
inputting the source with the mask into a training model to obtain a prediction result;
calculating a precision and a recall according to the source, the target, and the prediction result of the sample label;
calculating an average precision and an average recall for the precisions and the recalls of a plurality of sample labels, and calculating a harmonic mean F1 of the precisions and the recalls according to the average precision and the average recall; and
adjusting the training model according to the harmonic mean F1 and taking the adjusted training model as a text error correction model.

2. The text error correction method according to claim 1, wherein the harmonic mean
$$F 1 = \frac{2 * precision * recall}{( precision + recall )} .$$

3. The text error correction method according to claim 1, further comprising:
according to whether an error in the source occurs for the first time for the training model, classifying the plurality of sample labels into two classes, a first class being sample labels where the error in the source occurs for the first time for the training model, and a second class being sample labels where the error in the source does not occur for the first time for the training model.

4. The text error correction method according to claim 3, further comprising:
averaging precisions and recalls of the plurality of sample labels in the first class and the second class, respectively, to obtain an average precision and an average recall of the first-class sample labels and an average precision and an average recall of the second-class sample labels; and
calculating E-F1 according to the average precision and the average recall of the first-class sample labels, and calculating I-F1 according to the average precision and the average recall of the second-class sample labels, wherein E-F1 is a harmonic mean F1 of the precisions and the recalls of the training model on those errors having not been seen in training, and I-F1 is a harmonic mean F1 of the precisions and the recalls of the training model on those errors having been seen in training.

5. The text error correction method according to claim 1, wherein a ratio of randomly adding the mask to the source is 0.1 to 0.3.

6. The text error correction method according to claim 1, further comprising:
inputting a source to be corrected into the text error correction model to obtain a corrected target.

7. An electronic device, comprising:
a memory; and
a processor coupled to the memory, the memory having therein stored instructions which, when executed by the processor, cause the electronic device to perform a text error correction method, comprising:
obtaining a sample label comprising a source and a target, and randomly adding a mask to the source in the sample label to obtain the source with the mask;
inputting the source with the mask into a training model to obtain a prediction result;
calculating a precision and a recall according to the source, the target, and the prediction result of the sample label;
calculating an average precision and an average recall for the precisions and the recalls of a plurality of sample labels, and calculating a harmonic mean F1 of the precisions and the recalls according to the average precision and the average recall; and
adjusting the training model according to the harmonic mean F1 and taking the adjusted training model as a text error correction model.

8. The electronic device according to claim 7, wherein the harmonic mean
$$F 1 = \frac{2 * precision * recall}{( precision + recall )} .$$

9. The electronic device according to claim 7, wherein the method further comprises:
according to whether an error in the source occurs for the first time for the training model, classifying the plurality of sample labels into two classes, a first class being sample labels where the error in the source occurs for the first time for the training model, and a second class being sample labels where the error in the source does not occur for the first time for the training model.

10. The electronic device according to claim 9, wherein the method further comprises:
averaging precisions and recalls of the plurality of sample labels in the first class and the second class, respectively, to obtain an average precision and an average recall of the first-class sample labels and an average precision and an average recall of the second-class sample labels; and
calculating E-F1 according to the average precision and the average recall of the first-class sample labels, and calculating I-F1 according to the average precision and the average recall of the second-class sample labels, wherein E-F1 is a harmonic mean F1 of the precisions and the recalls of the training model on those errors having not been seen in training, and I-F1 is a harmonic mean F1 of the precisions and the recalls of the training model on those errors having been seen in training.

11. The electronic device according to claim 7, wherein a ratio of randomly adding the mask to the source is 0.1 to 0.3.

12. The electronic device according to claim 7, wherein the method further comprises:
inputting a source to be corrected into the text error correction model to obtain a corrected target.

13. A non-transitory computer-readable storage medium having thereon stored a computer program which, when executed by a processor, implements a text error correction method, comprising:
obtaining a sample label comprising a source and a target, and randomly adding a mask to the source in the sample label to obtain the source with the mask;
inputting the source with the mask into a training model to obtain a prediction result;
calculating a precision and a recall according to the source, the target, and the prediction result of the sample label;
calculating an average precision and an average recall for the precisions and the recalls of a plurality of sample labels, and calculating a harmonic mean F1 of the precisions and the recalls according to the average precision and the average recall; and
adjusting the training model according to the harmonic mean F1 and taking the adjusted training model as a text error correction model.

14. The non-transitory computer-readable storage medium according to claim 13, wherein the harmonic mean
$$F 1 = \frac{2 * precision * recall}{( precision + recall )} .$$

15. The non-transitory computer-readable storage medium according to claim 13, wherein the method further comprises:
according to whether an error in the source occurs for the first time for the training model, classifying the plurality of sample labels into two classes, a first class being sample labels where the error in the source occurs for the first time for the training model, and a second class being sample labels where the error in the source does not occur for the first time for the training model.

16. The non-transitory computer-readable storage medium according to claim 15, wherein the method further comprises:
averaging precisions and recalls of the plurality of sample labels in the first class and the second class, respectively, to obtain an average precision and an average recall of the first-class sample labels and an average precision and an average recall of the second-class sample labels; and
calculating E-F1 according to the average precision and the average recall of the first-class sample labels, and calculating I-F1 according to the average precision and the average recall of the second-class sample labels, wherein E-F1 is a harmonic mean F1 of the precisions and the recalls of the training model on those errors having not been seen in training, and I-F1 is a harmonic mean F1 of the precisions and the recalls of the training model on those errors having been seen in training.

17. The non-transitory computer-readable storage medium according to claim 13, wherein a ratio of randomly adding the mask to the source is 0.1 to 0.3.

18. The non-transitory computer-readable storage medium according to claim 13, wherein the method further comprises:
inputting a source to be corrected into the text error correction model to obtain a corrected target.
